(19) United States
(12) Patent Application Publication
(10) Pub. No.: US 2013/0246854 A1
(43) Pub. Date: Sep. 19, 2013

(54) WIRELESS COMMUNICATION CHECK SYSTEM AND METHOD

(71) Applicant: HON HAI PRECISION INDUSTRY CO., LTD., New Taipei (TW)

(72) Inventors: CHUNG-JEN HSIEH, New Taipei (TW); MING-SHIU OU YANG, New Taipei (TW); WEI-YUAN CHEN, New Taipei (TW)

(73) Assignee: HON HAI PRECISION INDUSTRY CO., LTD., New Taipei (TW)

(21) Appl. No.: 13/832,396

(22) Filed: Mar. 15, 2013

(30) Foreign Application Priority Data
Mar. 19, 2012 (TW) 101109269

(51) Int. Cl. G06F 11/07

(52) U.S. Cl. CPC G06F 11/079
USPC 714/37

(57) ABSTRACT

A wireless communication check method using a monitoring device. The monitoring device sends commands to a wireless check device embeded in into a check system, and invokes a wireless check device to check firmware embeded in into components of the check system. The monitoring device receives a check report from the wireless check device, and analyzes the check report to determine if the firmware embeded in into the components of the check system includes error. The monitoring device sends check data to the check system and notifies the wireless check device to update the firmware having error using the check data.

### BACKGROUND

1. Technical Field

The embodiments of the present disclosure relate to wireless communication technology, and particularly to a wireless communication check system and method.

2. Description of Related Art

An electronic device (e.g., a personal computer) includes a plurality of components (e.g., a baseboard management controller (BMC), a basic input/output system (BIOS) chip, a storage disk, a processor, a chipset, and so on). The components may include firmware. For example, the BMC and BIOS in the electronic device include firmware. The firmware in the BMC or the BIOS may include configuration information of the electronic device. However, in some situations, the configuration information stored in the firmware may be ruined or need to be upgraded. Methods to overwrite, recover, check or upgrade the firmware in the electronic device are complex.

### BRIEF DESCRIPTION OF THE DRAWINGS

FIG. 1 is a system view of one embodiment of a monitoring device which communicates with one or more check systems.

FIG. 2 is a block diagram of one embodiment of a wireless communication check system included in the monitoring device.

FIG. 3 is a flowchart of one embodiment of a wireless communication check method using the wireless communication check system.

FIG. 4 is a block diagram of one embodiment of the wireless check device embeded in into the check system.

FIG. 5 is a flowchart of one embodiment of the wireless communication check method using the wireless check device.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean “at least one.”

In general, the word “module,” as used herein, refers to logic embodied in hardware or firmware, or to a collection of software instructions, written in a programming language. One or more software instructions in the modules may be embedded in firmware, such as in an erasable programmable read only memory (EPROM). The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

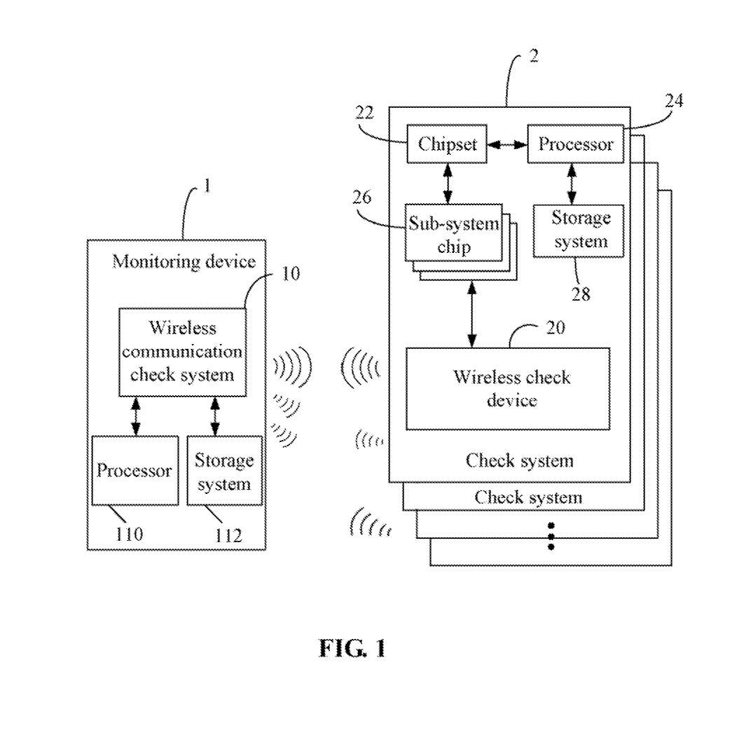

FIG. 1 is a system view of one embodiment of a monitoring device 1 which communicates with one or more check systems 2. In one embodiment, the monitoring device 1 is connected to the one or more check system 2 using a wireless connection. The wireless connection may be , but is not limited to, a BLUETOOTH connection, a local area network, a global system for mobile communication (GSM) network, or a code division multiple access (CDMA) for mobile communication network.

The monitoring device 1 includes a wireless communication check system 10, a processor 110 and a storage system 112. The monitoring device 1 may be, but is not limited to, a tablet computer, a desktop computer, a laptop, a server, a data center, or any other electronic device.

Each check system 2 includes a wireless check device 20, a chipset 22, a processor 24, a sub-system chip 26, and a storage system 28. In one embodiment, the wireless check device 20 may be, but is not limited to, an embedded device. The chipset 22 may be, but are not limited to, a north bridge, a south bridge or any other microchip embeded in into the check system 2. The sub-system chip 26 may be, but are not limited to, a baseboard management controller (BMC), a basic input/output system (BIOS) chip, or a serial attached SCSI (SAS) expander. The wireless check device 20 includes a wireless communication unit for wirelessly communicating with the monitoring device 1. The wireless check device 20 is remotely controlled by the monitoring device 1 to check if the firmware inside the check system 2 includes errors. The firmware may be embeded in into one or more components (e.g., the chipset 22, the sub-system chip 26) of the check system 2. For example, if the sub-system chip 26 is the BMC, the wireless check device 20 checks if the firmware embeded in into the BMC includes errors. The wireless check device 20 is connected to the components which include firmware using an interface (e.g., an inter-integrated circuit interface, a joint test action group (JTAG) interface or a serial peripheral interface).

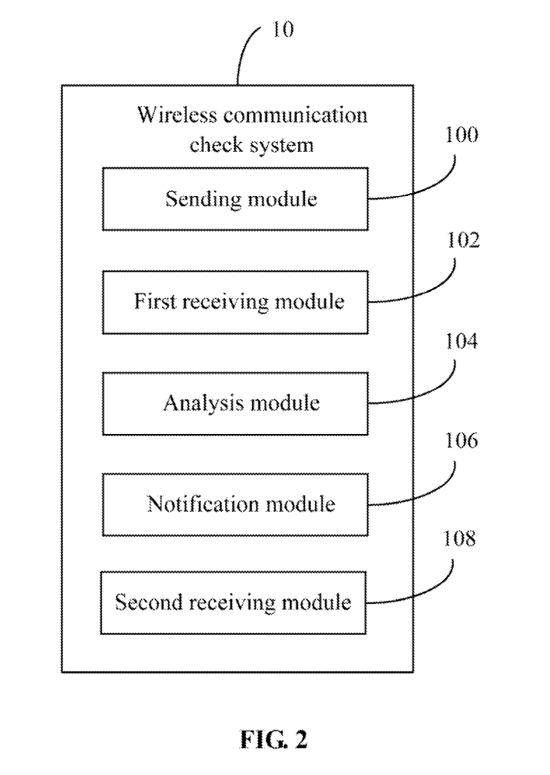

FIG. 2 is a block diagram of one embodiment of the wireless communication check system 10. The wireless communication check system 10 includes a sending module 100, a first receiving module 102, an analysis module 104, a notification module 106, and a second receiving module 109. The modules 100-108 may include computerized code in the form of one or more programs that are stored in the storage system 112. The computerized code includes instructions that are executed by the at least one processor 110 to provide functions for the modules 100-108. The storage system 112 may be a memory, such as an EPROM, hard drive disk (HDD), or flash memory.

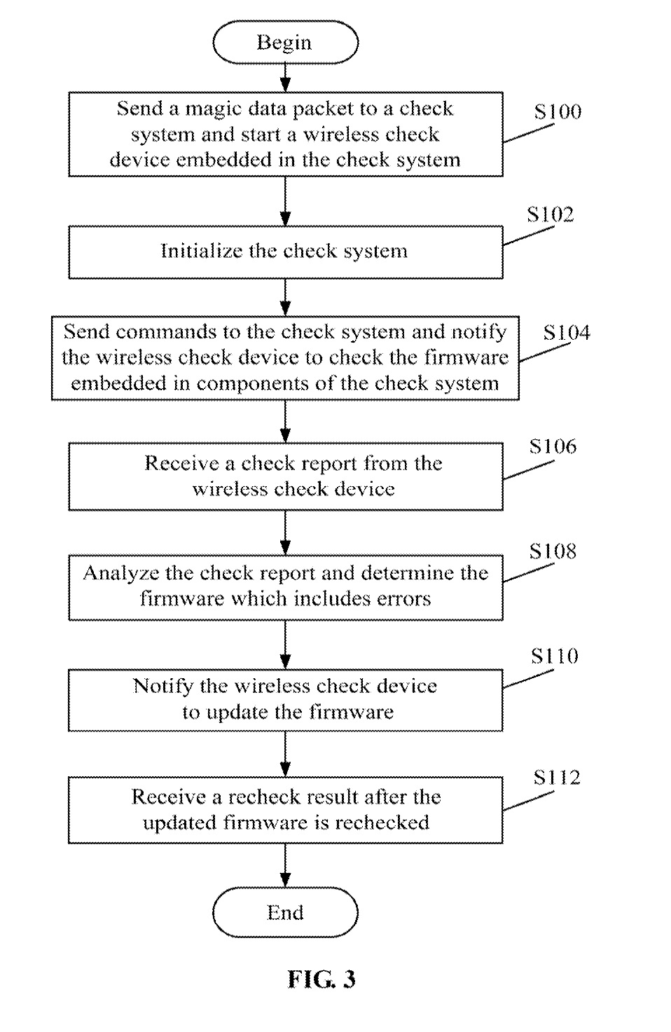

FIG. 3 is a flowchart of one embodiment of a wireless communication check method using the wireless communication check system 10. Depending on the embodiment, additional steps may be added, others deleted, and the ordering of the blocks may be changed.

In step S100, the sending module 100 sends a packet to the wireless check device 20. The packet may be a magic packet for starting the wireless check device 20. The wireless check device 20 is woken when receiving the magic packet. It is noted that if the wireless check device 20 is already in a work state, step 100 can be omitted.

In step S102, the sending module 100 sends first commands to the wireless check device 20, to enable the wireless check device 20 to initialize the components of the check system 2.

In step S104, the sending module 100 sends second commands to the wireless check device 20, to enable the wireless check device 20 to check the firmware embeded in into the components of the check system 2. The wireless check device 20 saves a check result into a check report and sends the check report to the monitoring device 1. The check result may include a tag that indicates if the firmware includes errors or not. Additionally, the check result includes a start time when starting checking the firmware and an end time when finishing checking the firmware. The wireless check device 20 also checks the chipset 22, the processor 24, sub-system chip 26 and the storage system 28, and saves the check results into the check report. The check report includes the check results and names of the components.

In step S106, the first receiving module 102 receives the check report from the wireless check device 20.

In step S108, the analysis module 104 analyzes the check report and determines if the firmware includes errors. In one embodiment, the analysis module 104 determines the firmware includes errors by analyzing the tag included in the check report.

In step S110, the notification module 106 sends check data to the check system 2 and notifies the wireless check device 20 to update the firmware having errors using the check data. The check data may be, but is not limited to, a new version of the firmware. The notification module 106 also notifies a user. The user may be notified using a pop-up shown in a screen of the check system 2, an e-mail message sent to an e-mail address of the user or an audio message generated by a audio device of the check system 2. The wireless check device 20 also re-checks the firmware after the firmware is updated. The wireless check device 20 generates a re-check result after the updated firmware is rechecked. The re-check result indicates if the firmware includes the errors after the updated firmware is rechecked.

In step 112, the second receiving module 108 receives a re-check result from the wireless check device 20.

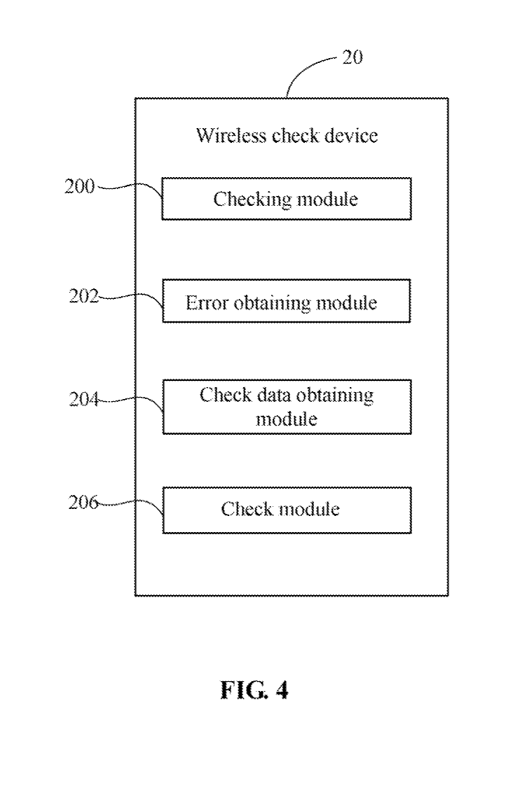

FIG. 4 is a block diagram of one embodiment of the wireless check device 20 included in the check system 2. The wireless check device 20 includes a checking module 200, an error obtaining module 202, a check data obtaining module 204, and a check module 206. The modules 200-206 may include computerized code in the form of one or more programs that are stored in the storage system of the wireless check device 20. The computerized code includes instructions that are executed by the at least one processor of the wireless check device 20 to provide functions for the modules 200-206.

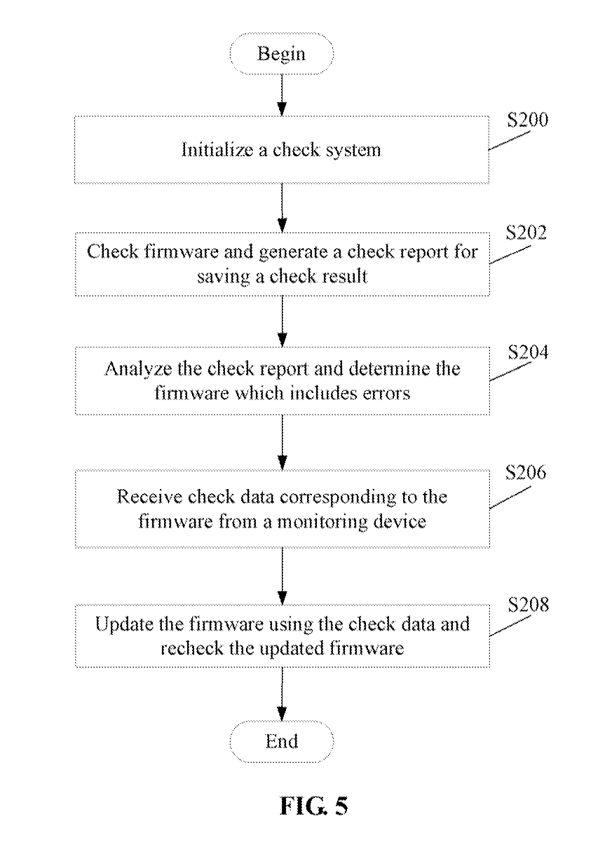

FIG. 5 is a flowchart of one embodiment of a wireless communication check method using the wireless check device 2. Depending on the embodiment, additional steps may be added, others deleted, and the ordering of the blocks may be changed.

In step 200, the checking module 200 initializes the check system 2. In one embodiment, the checking module initializes the chipset 22, the processor 24, the sub-system chip 26, and the storage system 28.

In step 202, the checking module 202 checks the firmware embeded in into the components of the check system 2 and generates a check report for saving a check result.

In step 204, the error obtaining module 204 analyzes the check report and determines the firmware which includes errors.

In step 206, the check data obtaining module 204 receives check data corresponding to the firmware from the monitoring device 1. As mentioned above, the check data may be a version of the firmware. For example, if the firmware embeded in into the BMC includes errors, the check data obtaining module 204 receives a new version of the firmware of the BMC from the monitoring device 1.

In step 208, the check module 206 updates the firmware using the check data and re-checks the updated firmware. The check module 206 also generates a re-check result after the updated firmware is rechecked. As mentioned above, the re-check result indicates if the firmware includes the errors after the firmware is rechecked.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A monitoring device, the monitoring device in communication with a check system, comprising:
a storage system storing check data;
at least one processor; and
one or more programs stored in the storage system and being executable by the at least one processor, the one or more programs comprising:
a sending module enables a wireless check device embeded in into the check system to check firmware embeded in into components of the check system by sending commands to the wireless check device;
a first receiving module receives a check report from the wireless check device;
an analysis module determines if the firmware embeded in into the components comprises errors by analyzing the check report; and
a notification module sends the check data to the check system and notifies the wireless check device to update the firmware using the check data, in response to a determination that the firmware comprises errors.

2. The monitoring device of claim 1, wherein the check data is a new version of the firmware.

3. The monitoring device of claim 1, wherein the check result comprises a tag that indicates if the firmware comprises errors or not, a start time when starting checking the firmware and an end time when finishing checking the firmware.

4. The monitoring device of claim 1, further comprising a second receiving module that receives a re-check result from the wireless check device.

5. The monitoring device of claim 4, wherein the re-check result indicates if the updated firmware comprises the errors after the firmware is rechecked.

6. A wireless communication check method implemented by a monitoring device, the monitoring device in communication with a check system, the method comprising:
enabling a wireless check device embeded in into the check system to check firmware embeded in into components of the check system by sending commands to the wireless check device;
receiving a check report from the wireless check device;
determining if the firmware embeded in into the components comprises errors by analyzing the check report; and
sending check data to the check system and notifying the wireless check device to update the firmware using the check data, in response to a determination that the firmware comprises errors.

7. The method of claim 6, wherein the check data is a new version of the firmware.

8. The method of claim 6, wherein the check result comprises a tag that indicates if the firmware comprises errors or not, a start time when starting checking the firmware and an end time when finishing checking the firmware.

9. The method of claim 6, further comprising:
receiving a re-check result from the wireless check device.

10. The method of claim 9, wherein the re-check result indicates if the updated firmware comprises the errors after the firmware is rechecked.

11. A non-transitory computer-readable medium having stored thereon instructions that, when executed by a monitoring device, the monitoring device in communication with a check system, causing monitoring device to perform a wireless communication check method, the method comprising:
enabling a wireless check device embeded in into the check system to check firmware embeded in into components of the check system by sending commands to the wireless check device;
receiving a check report from the wireless check device;
determining if the firmware embeded in into the components comprises errors by analyzing the check report; and
sending check data to the check system and notifying the wireless check device to update the firmware using the check data, in response to a determination that the firmware comprises errors.

12. The medium of claim 11, wherein the check data is a new version of the firmware.

13. The medium of claim 11, wherein the check result comprises a tag that indicates if the firmware comprises errors or not, a start time when starting checking the firmware and an end time when finishing checking the firmware.

14. The medium of claim 11, further comprising:
receiving a re-check result from the wireless check device.

15. The medium of claim 14, wherein the re-check result indicates if the updated firmware comprises the errors after the firmware is rechecked.
